(19) United States
(12) Patent Application Publication
(10) Pub. No.: US 2013/0150138 A1
(43) Pub. Date: Jun. 13, 2013

(54) BLACKJACK VARIATION WITH OPPORTUNITY FOR GRATUITOUS BETS

(71) Applicant: Geoff Hall, Solihull (GB)

(72) Inventor: Geoff Hall, Solihull (GB)

(21) Appl. No.: 13/659,912

(22) Filed: Oct. 25, 2012

Related U.S. Application Data
(63) Continuation-in-part of application No. 13/425,408, filed on Mar. 20, 2012, now Pat. No. 8,382,568.
Application No. 13/425,408 is a continuation of application No. 12/127,785, filed on May 27, 2008, now Pat. No. 8,157,632.
Application No. 12/127,785 is a continuation-in-part of application No. 11/611,842, filed on Dec. 15, 2006, now abandoned.
(60) Provisional application No. 61/551,424, filed on Oct. 25, 2011.
(60) Provisional application No. 61/551,910, filed on Oct. 26, 2011.
(60) Provisional application No. 61/564,492, filed on Nov. 29, 2011.

(51) Int. Cl. A63F 1/00; A63F 13/00

(52) U.S. Cl. CPC A63F 1/00; A63F 13/005
USPC 463/12; 273/292

(57) ABSTRACT

A method, apparatus, and non-transitory computer readable storage medium to implement a blackjack variation which, in certain instances, provides the player an opportunity to make a free wager. If the player has a predetermined total on the first two cards, then the player can be provided a free double bet (the player can choose to take the free bet or not). If the player has a predetermined set of identically ranked cards on the first two cards, then the player can be provided a free split bet (the player can choose to take the free bet or not).

### CROSS REFERENCES TO RELATED APPLICATIONS

This Application claims benefit to U.S. provisional application 61/551,424, filed on Oct. 25, 2011. This Application also claims benefit to U.S. provisional application 61/551,910, filed on Oct. 26, 2011. This Application also claims benefit to U.S. provisional application 61/564,492, filed on Nov. 29, 2011. All three of these applications (61/551,424; 61/551,910; 61/564,492) are incorporated by reference herein in their entireties. This application is also a continuation in part application of U.S. application Ser. No. 13/425,408, which is a continuation of application Ser. No. 12/127,785, which is a continuation in part of application Ser. No. 11/611,842. All three of these applications (Ser. Nos. 13/425,408; 12/127,785; 11/611,842) are incorporated by reference in their entireties.

### BACKGROUND OF THE INVENTION

1. Field of the Invention

The present general inventive concept is directed to a method, apparatus, and computer readable storage medium directed to a blackjack variation that can be played in a casino or on the Internet.

2. Description of the Related Art

The casino game of blackjack is well known, for example see U.S. Patent publication 2003/0155715 which is incorporated by reference herein in its entirety.

FIG. 1 is a flowchart illustrating a method of implementing the known game of blackjack.

Points totals are computed by adding the standard rank value of each card, with face valued cards (tens, jacks, queens, kings) being given a value of 10, and aces being given a value of 1 or 11, whichever results in a better hand. A soft point total is where at least one ace is given the value of 11. A hard point total is a hand with all aces counting as 1.

In operation 100, the player makes a main wager by placing chips on a table. Then, in operation 102, the dealer deals two initial cards to each player (either face up or face down) and two initial cards to the dealer, typically one face down (“hole-card”), and one face up (the “up-card”). Then the player can decide whether to hit, stand, double, or split. If the player decides to hit, then the method proceeds to operation 106, which deals an additional card to a player. If a determination 108 determines that the player has busted (the player's hard point total is over 21), then the player loses the game and thus loses the main wager in operation 110, which ends the game. If the determination 108 determines that the player has not busted, then the method returns to operation 104, where the player can make another decision whether to hit or stand. In operation 104, the player can also double (not pictured) by place an additional wager of up to the main wager, but the player is limited to drawing only one additional card before the player must stand. Typically, the player is only permitted to double on the player's initial first two cards, although in another embodiment the player can double on three or more cards dealt to the player. The double wager placed is resolved at the end of the game in the same manner as the main wager—if the main wager wins, ties, or loses, then the double wager wins, ties, or loses respectively. Like the main wager, a winning double wager is also typically paid at even money (1:1).

If the player stands and has not busted out (either stands on his or her initial two cards or draws cards but has a point total under 22 and then stands), then the method proceeds to operation 112, which reveals all dealer's cards (e.g., turns the hole-card face up) and which then plays out the dealer's hand according to predetermined rules. If the dealer's total is greater than a predetermined amount (typically 17), then the dealer stands (proceeds to operation 122). If the dealer's total is not greater than the predetermined amount, the method proceeds to operation 116 which deals an additional card to the dealer. If it is then determined 118 that the dealer has not busted (has a point total over 21), the method returns to operation 114. If the dealer has busted, then the player wins the game and the main wager in operation 120 (this assumes the player has not also busted; if the player has already busted then the player would have lost in operation 110).

In operation 122, both the player and the dealer have played out their hand and neither have busted. Thus, their respective point totals (adding the numerical values of each card in the hand) are compared. If the dealer's point total is determined in operation 124 to be lower than the player's point total, then the player wins the game and the main wager in operation 120. Otherwise, if the dealer's point total is determined 128 to be greater than the player's point total, then the player loses the game and the main wager in operation 130. If the player's point total ties the dealer's point total, then that results in a “push” in operation 126 in which the player doesn't win or lose the main wager (the main wager bet is a wash).

If a player is initially dealt two identically ranked cards in operation 102, players can also split in operation 104 by placing an additional split wager equal in value to the main wager, and the player's two initial cards are separated and the dealer deals an additional card on each. The player then plays out each of the two separate hands, each from operation 104. Depending on house rules, players may or may not be allowed to resplit cards.

What is needed is a new and entertaining version of blackjack which provides players additional and exciting options not provided for in the basic game.

### SUMMARY OF THE INVENTION

It is an aspect of the present invention to provide an exciting casino game.

The above aspects can be obtained by a method that comprises (a) providing at least one physical deck of cards; (b) providing free double rules which comprise when the player is initially dealt a two card hand in a set of qualifying two card hands, the player is provided an opportunity to make a free double wherein the a free double wager is made without the player having to use the player's own money, and upon resolving of the main wager if the player wins the main wager then the player wins the free double wager and if the player loses the main wager then the player does not lose any money in addition to the main wager; (c) receiving a main wager from a player; (d) dealing an initial hand to the player and an initial hand to the dealer; (e) implementing the free double rules; (f) continuing and completing the blackjack game; and (g) resolving the main wager.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing the known game of blackjack;

FIG. 2 is a flowchart illustrating an exemplary method of playing a blackjack variation offering the player a second chance after receiving a bust card, according to an embodiment;

FIG. 3 is a drawing or a sample table layout, according to an embodiment;

FIG. 4 is a block diagram illustrating hardware that can be used to implement electronic versions of the wagering methods described herein, according to an embodiment;

FIG. 5 is a flowchart illustrating an exemplary method of offering the player a free double, according to an embodiment;

FIG. 6 is a flowchart illustrating an exemplary method of offering the player a free split, according to an embodiment;

FIG. 7A is a drawing illustrating a first stage of a double using free chips, according to an embodiment;

FIG. 7B is a drawing illustrating a second stage of a double using free chips, according to an embodiment;

FIG. 7C is a drawing illustrating a third stage of a double using free chips, according to an embodiment;

FIG. 7D is a drawing illustrating a first stage of a double using a non-cash value chip, according to an embodiment;

FIG. 7E is a drawing illustrating a second stage of a double using a non-cash value chip, according to an embodiment;

FIG. 7F is a drawing illustrating a third stage of a double using a non-cash value chip, according to an embodiment;

FIG. 8A is a drawing illustrating a first stage of a split using free chips, according to an embodiment;

FIG. 8B is a drawing illustrating a second stage of a split using free chips, according to an embodiment;

FIG. 8C is a drawing illustrating a third stage of a split using free chips, according to an embodiment;

FIG. 8D is a drawing illustrating a fourth stage of a split using free chips, according to an embodiment;

FIG. 9A is a drawing illustrating a first stage of a split using a non-cash value chip, according to an embodiment;

FIG. 9B is a drawing illustrating a second stage of a split using a non-cash value chip, according to an embodiment;

FIG. 9C is a drawing illustrating a third stage of a split using a non-cash value chip, according to an embodiment; and

FIG. 9D is a drawing illustrating a fourth stage of a split using a non-cash value chip, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a blackjack variation.

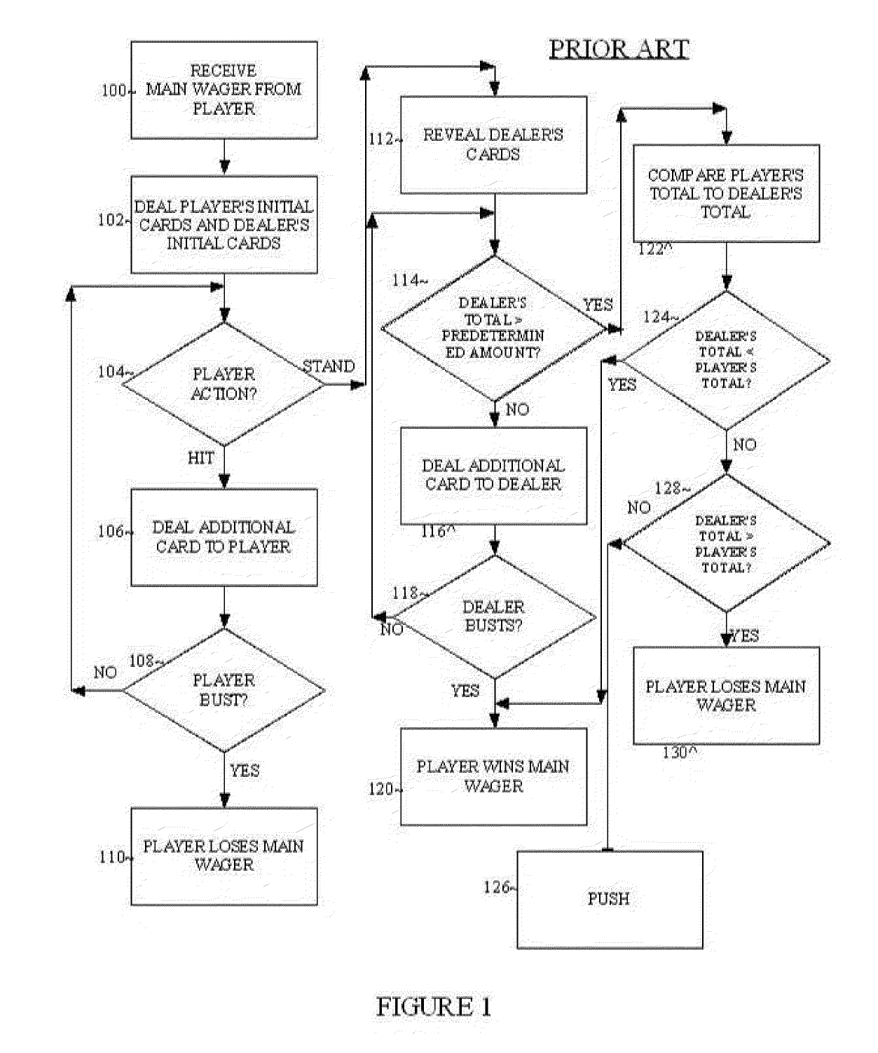

FIG. 1 is a flowchart illustrating a method of implementing the known game of blackjack.

In general, casino blackjack is played by one or more players at a gaming table against a dealer using one or more decks of cards (each deck can be a standard 52 card deck). The idea is for the player to make a point total closest to 21 without going over 21 (busting). Each player (after making a main wager) is dealt two initial cards (typically face up) and the dealer is also dealt two cards (one face up—the upcard, and one face down—the hole card). The player can stand on his or her initial two cards, or continuously hit (take another card) until the player stands or the player's point total is over 21 (upon which the player automatically loses). If the player has not busted, then after the player stands the dealer will play out the dealer's hand according to predetermined rules. One set of dealer predetermined rules is as follows: the dealer will continuously hit until the dealer's point total is greater than 16. Once the dealer has resolved the dealer's hand, the wager is resolved. If the player has busted then the player loses (the main wager). If the player has not busted but the dealer has busted (the dealer's point total is over 21) then the player wins (wins even money on the main wager). If both the player and the dealer have not busted, then if the player's point total is higher than the dealer's point total then the player wins (wins even money on the main wager). If both the player and the dealer have no busted, then if the dealer's point total is higher than the player's point total then the dealer wins (the player loses the main wager). If the player's point total equals the dealer's point total, then the main wager pushes (neither wins nor loses). Other options the player may have at his or her disposal is to double down or split. Cards are given their standard numerical value (i.e., aces count as 1 or 11 (whichever makes the best hand), 2's-10's count as their respective face value, jacks, queens, and kings all count as 10).

The present inventive concept is a blackjack game that provides the player an opportunity to bust (go over a point total of 21) and have a chance to not lose the player's main wager. In the prior art game of blackjack, if a player busts he automatically loses and his/her wager is taken. In contrast to the prior art game of blackjack, in an embodiment of the present invention, if a player's bust card (the card that caused the player to bust) is not a 10-valued card (10, jack, queen, king) then the player remains in the game. If the player's bust card is a 10-valued card, then the player busts and automatically loses (as in the prior art game).

If the player's bust card is not a 10-valued card, then the player has the potential to push his/her wager or win his/her wager depending on how the dealer's hand is resolved. If the dealer busts under certain conditions, then the player's wager would push (or win depending on the embodiment). The certain conditions can be if the dealer's initial up-card is a bust card (e.g., 4, 5 or 6) and the following two cards are 10-valued cards. This is referred to herein as a “bust card/10/10 bust” because the qualifying bust must be a three card bust of a bust card followed by a 10-valued card followed by a 10-valued card (in that order). This can also be referred to as a “qualifying bust”, in that if the dealer has a qualifying bust then game qualifies for certain rule deviations.

One advantage of a structure as described is that the game would be less susceptible to card counters. Typically, card counters track the composition of remaining cards in the deck (or shoe). Large cards (such as 10's) are good for the player, while small cards (such as 4, 5, 6) are good for the house. Thus, when there is a relatively large quantity of large cards remaining to be dealt, a card counter would typically raise his/her bet, while if there is a relatively small quantity of large cards remaining (or a large quantity of small cards) then the card counter would typically bet a small amount.

In the invention described herein, if the player busts on a non-10 valued card (2 through 9 and ace) then instead of automatically losing, the player would have an opportunity to salvage his main wager by pushing (or possibly even winning). If the player busts with a 10-valued card, then the player would automatically lose. In this manner, 10-valued cards have a disadvantage over non-10-valued cards in that the non-10-valued cards give the player a “second chance” if the player's bust-card is a non-10 valued card. This gives 10-valued cards a “negative” quality for the player, in that busting with a 10-valued card is worse than busting with a non-10-valued cards. Thus, card counters who capitalize on the benefits of having a good proportion of 10-valued cards remaining in the deck (shoe) will see less benefits of 10-valued cards. This would help thwart card counters since 10-valued cards are no longer so advantageous for the player.

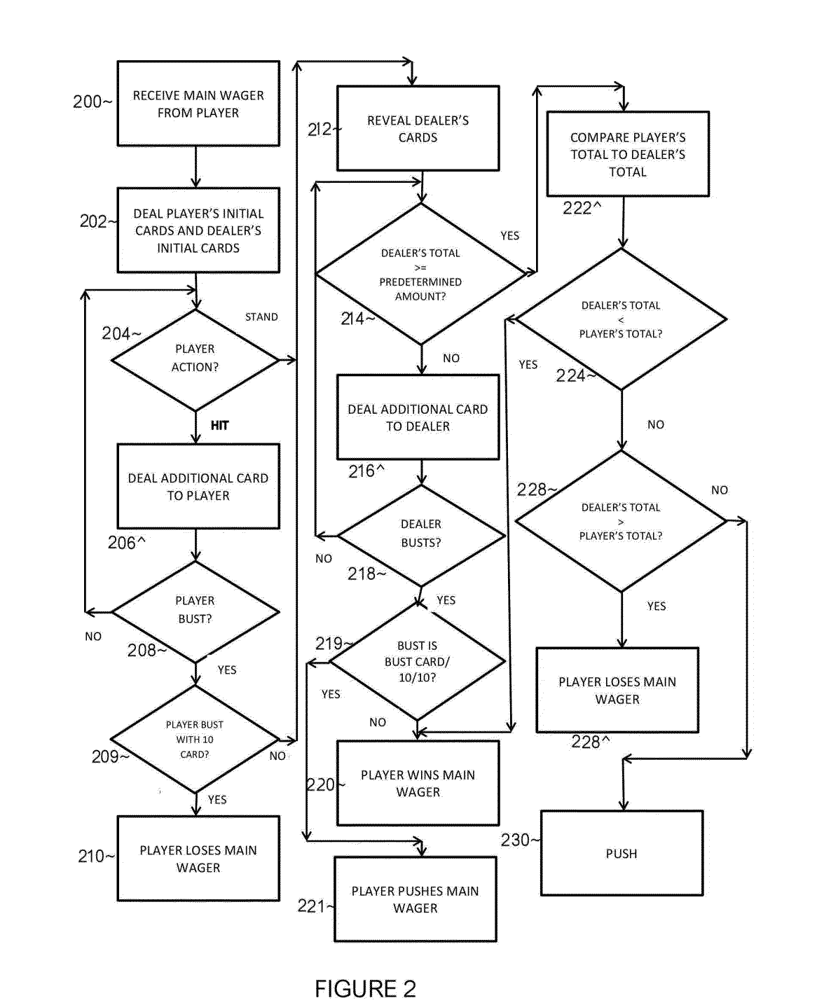

FIG. 2 is a flowchart illustrating an exemplary method of playing a blackjack variation offering the player a second chance after receiving a bust card, according to an embodiment.

FIG. 2 is performed similarly to FIG. 1 (operation number is performed similarly to the counterpart operation (the same number minus 100) in FIG. 1) with the addition of operations 209 and 219.

In operation 209, it is determined if the player busted with a 10-valued card, then the method proceeds to operation 210 and the player loses the main wager (in other words, this is treated as a typical bust as in the prior art blackjack game). Thus, the player does not want to bust with a 10-valued card. For example, if the player has a point total of 13 (e.g., the player has a 9 and a 4) and hits and receives a 10, the player has busted (point total of 23) with a 10-valued card and the method proceeds to operation 210 wherein the player loses and the game ends. If the player hit his 13 and received a 9 (for a point total of 22), since the player's bust card (the card that caused the player to have a point total over 21) was not a 10-valued card, then the method proceeds to operation 212 wherein the game continues and the dealer resolves the dealer's hand. The player still has a chance to push the main wager (or even win it) instead of losing it in operation 210. Note that at this point, (depending on the embodiment being implemented), the dealer can remove the bust card from the player's hand (leaving the player with a point total of 12) or the dealer can leave the bust card on the player's hand (leaving the player with his point total of 22). A player who busts with a non-10 valued card is hoping that the dealer subsequently busts and busts without a qualifying bust (bust card/10/10) which goes to operation 220 wherein the player wins the wager.

The dealer resolves his hand according to FIG. 2 with the determination in operation 219 whether the dealer made a qualifying bust, that is, whether the dealer busted with a bust card (4-6) showing, then two consecutive 10-valued cards. If the dealer made a qualifying bust, then the method proceeds to operation 221, wherein all live bets on the table are pushed (not including bets that have already lost in operation 210) and the game ends. Players would typically not want the dealer to get a qualifying bust, because a non-qualifying bust would mean all players with live bets on the table (regardless of their point totals) will win. In an embodiment, if the player has blackjack then the player would still be paid (either 3:2 or 1:1) in operation 221. In an embodiment, if the player has a particular point total (e.g., a point total of 21 or other point total(s)) then that player would still be paid (at 1:1 or other payout) instead of pushing in operation 221.

Thus, in operation 219, if the dealer's bust is a qualifying bust then the method proceeds to operation 221 wherein all live player's bets (bets on the game that have not yet lost) push. In an alternative embodiment, all player's bets would lose instead of push. In operation 219, if the dealer's bust is not a qualifying bust then the method proceeds to operation 220, wherein the players win their live bets.

Players who have reached operation 212 from operation 209 (players who have busted but not with a 10-valued card) would typically win their main wager in operation 220 like all other live players. These players can be referred to as “players on hold.” In an alternative embodiment, these players can push their main wagers in operation 220 (while other live players who are not players on hold would win their wagers in operation 220).

It is noted that the qualifying bust can be other conditions aside from the dealer showing a 4-6 for the dealer's upcard and then revealing a 10-valued card (for the dealer's hole card) and then drawing another 10-valued card. For example, instead of 4-6 for the dealer's upcard, other ranges can be used as well, for example 3-6, 2-6, 3-7, 2-7, 4-8, or any other range (or non-continuous sets) of card values. In addition, instead of having to reveal two consecutive 10-valued cards after showing an up-card in the range of up-cards for the qualifying bust, other cards can be considered a qualifying bust as well. For example, a qualifying bust can be if the dealer's up-card is a 3-7 and the next two cards (the dealer's hole card and a drawn card) are either 10-valued cards or 9's. Or alternatively, a qualifying bust can be defined as having three cards (the dealer's up-card, the dealer's hole-card, and the dealer's drawn card) can comprise one card from a range of 4-6 and two 10-valued cards but the order does not matter (e.g., the up-card can be a 10-valued card, the hole card can be the card from 4-6, and the drawn card can be a 10-valued card). It is noted that if the dealer busts and the bust does not meet the criteria for a qualifying bust then the dealer's bust is considered a non-qualifying bust.

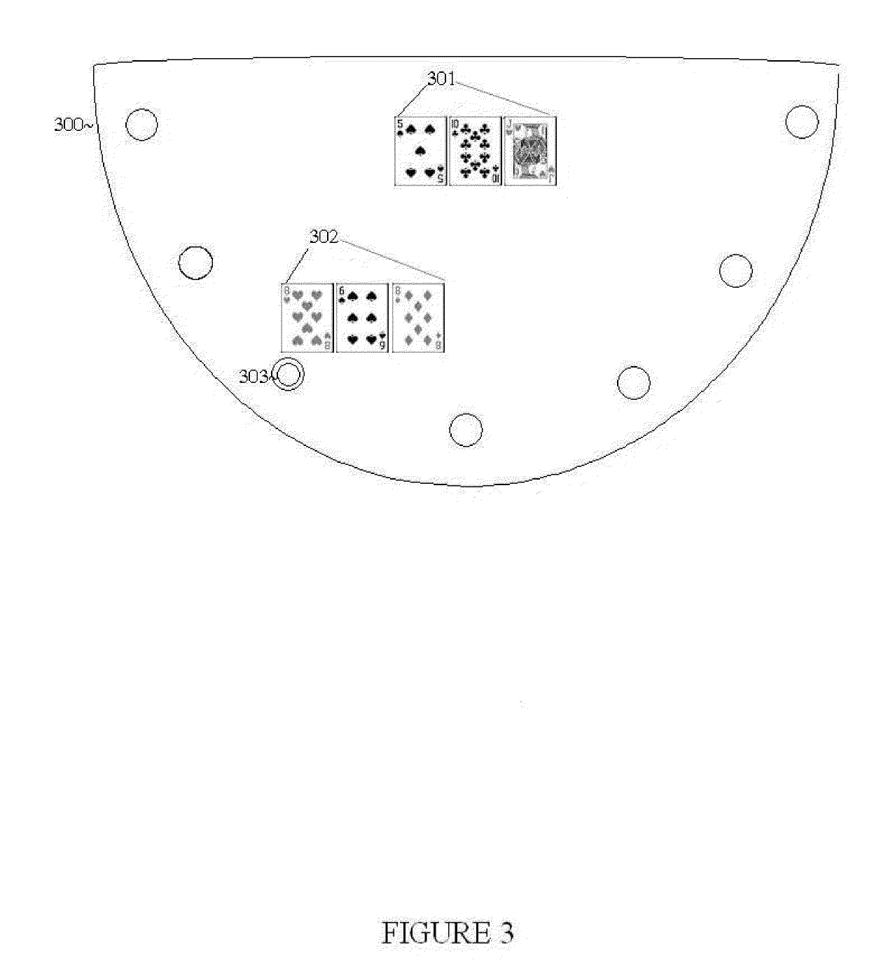

FIG. 3 is a drawing or a sample table layout, according to an embodiment.

A physical gaming table 300 accommodates seven simultaneous players, although of course such a table can accommodate other numbers of players as well. In FIG. 3, only one player is playing who made a main wager 303. The dealer's hand 301 and the player's hand have both been revealed. The dealer's up-card (dealt face up) was five-spades while the dealer's hole-card of 10-clubs was dealt face down (in operation 202). The player was initially dealt the eight-hearts and six-spades. The player decided to hit (in operation 206) and the player received the eight-diamonds which caused the player to bust (go over a point total of 21). Since the bust card (eight-diamonds) is not a 10-valued card, the player is a player on hold. The dealer then reveals the dealer's hole card of 10-clubs. Since the dealer's point total of 15 is less than 17, the dealer draws and receives the jack-hearts (the dealer's bust card). The dealer has now busted (since the dealer's point total of 25 is over 21) in operation 218. The dealer's bust is a qualifying bust because the up-card was a card from 4 to 6 and the next two cards are both 10-valued cards. Thus, the method has reached operation 221, wherein the player's wager pushes (neither wins nor loses and the player can now remove the wager 303 and keep it or rebet it).

It is noted that if the player had drawn a 10-valued card (e.g., 10, jack, queen, or king) instead of the eight-diamonds, then the player would have busted with a 10-valued card and reached operation 210 (where the player loses his wager). It is also noted that if the dealer had drawn a nine instead of the jack-hearts the dealer would have had a qualifying bust, and the method would have proceeded to operation 220, whereby the player (who was on hold) would have won his wager. In an alternative embodiment, players on hold who reach operation 220 would push their wagers instead of winning them.

Table I below illustrates possible conditions for a player to be a “player on hold,” that is due to the circumstances of his or her bust the player does not automatically lose and has a chance to push or win their bet. A player on hold could be considered to have a point total of under 17, and the player would only win if the dealer busts. Of course, these are merely examples and many other such conditions can be used as well.

TABLE I
1) Player busts on a card that is not a 10-valued card.
2) Player busts on a card that is not a 10-valued card or a 9.
3) Player busts on a card that is not a 10-valued card and the dealer must have a 4, 5 or 6
showing as the up-card.
4) Player busts on a card that is not as 10-valued card or a 9 and the dealer must have a 4,
5 or 6 showing as the up-card.
5) Player busts on a first drawn card only.

Table II below illustrates possible conditions for a qualifying bust, which would result in operation 221. Of course, these are merely examples and other conditions could be used as well.

TABLE II
1) The dealer has a 4, 5, or 6 as the up-card and the dealer's hole card is a 10-valued card
and the dealer's first draw card is a 10-valued card.
2) The dealer has a 2-6 as the up-card and the dealer's hole card is a 10-valued card and
the dealer's first draw card is a 10-valued card.
3) The dealer busts after drawing a single card and the three dealer's cards comprise a
card of 4, 5, or 6 and two 10-valued cards.
4) The dealer busts after drawing a single card and the three dealer's cards comprise a
card of 2-6 and two 10-valued cards.
5) The dealer has a 4, 5, or 6 as the up-card and the dealer's hole card is a 10-valued card
and the dealer's first draw card is a card from 8-10.

In a further embodiment, the player can receive bonuses (a “double bonus”) for initial hands of certain point totals. For example, the player can receive an even money (or 1:2) bonus if the players initial two cards is a particular point total (or totals), such as a total of 11 (or other totals such as 10). In one embodiment, any possible combination of cards that total 11 would qualify for this bonus. In another embodiment, only certain combinations that total 11 would qualify for this bonus (for example, only initial hands that comprise a 5/6 or 6/5; or only initial hands that comprise a 5/6 or 6/5 or 5/5; or only initial hands that are comprised of two 5's).

In one embodiment, the player is free to keep this bonus. In another embodiment, when the player receives the initial hand bonus the player must use that amount to double on the player's initial hand. For example, if the player bets $1 and is dealt a 5/6 and the dealer shows a 9, the player wins an instant initial hand bonus of $1 (which matches the original bet) which must be used to double the player's hand and so the dealer places the $1 bonus and the player doubles (just as if the player doubled on his own). If the player does not wish to double then the player would not receive the instant initial hand bonus.

In addition, when the player receives blackjack, instead of it paying 3:2, blackjack can pay even money (1:1) or some other multiple.

In addition to providing money for players to double, in an embodiment money can be given for players to split. For example, if the player bets $1 and is dealt 8,8, then the player automatically gets a $1 bonus (which matches the original bet) which is used to split the 8's (so the player does not have to put out extra money of his own to split). Splitting is well known in the blackjack art where the player is dealt two cards of the same rank and matches the initial wager (also known as the main wager) and plays out each hand as a separate hand. In this embodiment, the player would not be able to keep the $1 bonus but would be forced to use it for splitting (if the player does not wish to split then the player would not get the $1 bonus). This splitting bonus can be provided to the player for all initially dealt pairs or only certain ones. For example, for initial pairs of 7's, 8's, or 9's, the player would receive a bonus equal to their main wager so the player could split the pair but for all other pairs (2s-6s and A's) the player would not receive the splitting bonus (although the player could still split these hands if the player wants by matching their main wager using the player's own funds). Other sets of pairs could be used as well to offer the bonus. For example, if the player receives an initial hand of 2's, 3's, 5', or 9', the player would be offered the splitting bonus but for all other pairs the player would not receive the splitting bonus.

So in the latter example, assume the player makes a $1 main wager and is dealt a pair of 2's. The dealer places a $1 chip alongside the player's $1 main wager for splitting, although the player can decline this $1 bonus and choose not to split. The player then plays each 2 out separately, wherein the dealer deals an additional card on each 2, forming two separate initial hands of two cards each. The player can double on these two cards (or not be allowed depending on the embodiment) or hit or stand or split again (depending on the house rules) as with any other initial two card hand.

The splitting bonus described above can be combined with the splitting bonus or either one can be offered without the other. A Push on 22 rule (such as that described in U.S. Pat. No. 7,435,172 which is incorporated by reference herein in its entirety) can be offered to offset the player advantage of these bonuses.

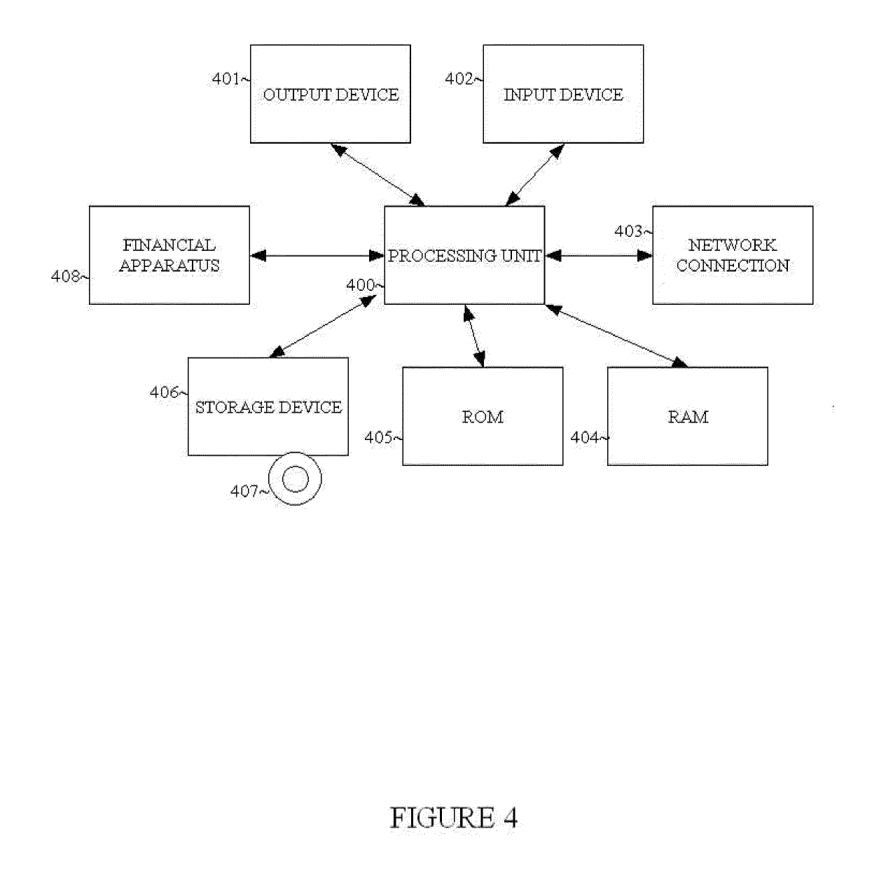

FIG. 4 is a block diagram illustrating hardware that can be used to implement electronic versions of any of the wagering methods described herein, according to an embodiment. The hardware can be, for example, an electronic gaming machine (EGM) used in casinos. The hardware can also be a personal computer, playing the game using the Internet at an Internet casino for real money. In the Internet casino embodiment, the game can be served by a server to a remote player via the internet wherein the server makes all random game determinations (e.g., the cards dealt) while the player (using a personal computer, cell phone, PDA, etc.) makes the player decisions (e.g., how much to bet, which course of action (hit, stand, etc.) to take remotely. The hardware can also be a digital casino table, for example the kind described in U.S. Pat. No. 7,775,887, which is incorporated by reference herein in its entirety.

A processing unit 400 (such as a microprocessor and any associated components) is connected to an output device 401 (such as an LCD monitor, touch screen, CRT, etc.) and an input device 402 (e.g., buttons, a touch screen, a keyboard, mouse, etc.) The output device 401 can display all activities occurring in the game (e.g., cards dealt, bets placed, winning/losing amounts, etc.) The input device 402 can be used to input all decisions needed from the player (e.g., how much to bet, what course of action to take (e.g., hit, stand), etc.) All methods described herein can be performed by the processing unit 400 by loading and executing respective instructions. The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a DVD-drive, CD-ROM, flash memory, or any other non-transitory compute readable storage medium. A computer readable storage medium 407 can store a program which can control the electronic device to perform any of the methods described herein. The processing unit 400 can also be connected to a financial apparatus 408 which can receive cash and convert the received cash into playable credits for use by the player when playing the electronic device. When the player decides to cash out any remaining credits, the financial apparatus 408 can issue coins or a cashless ticket (voucher) for the remaining credits which is redeemable by the player.

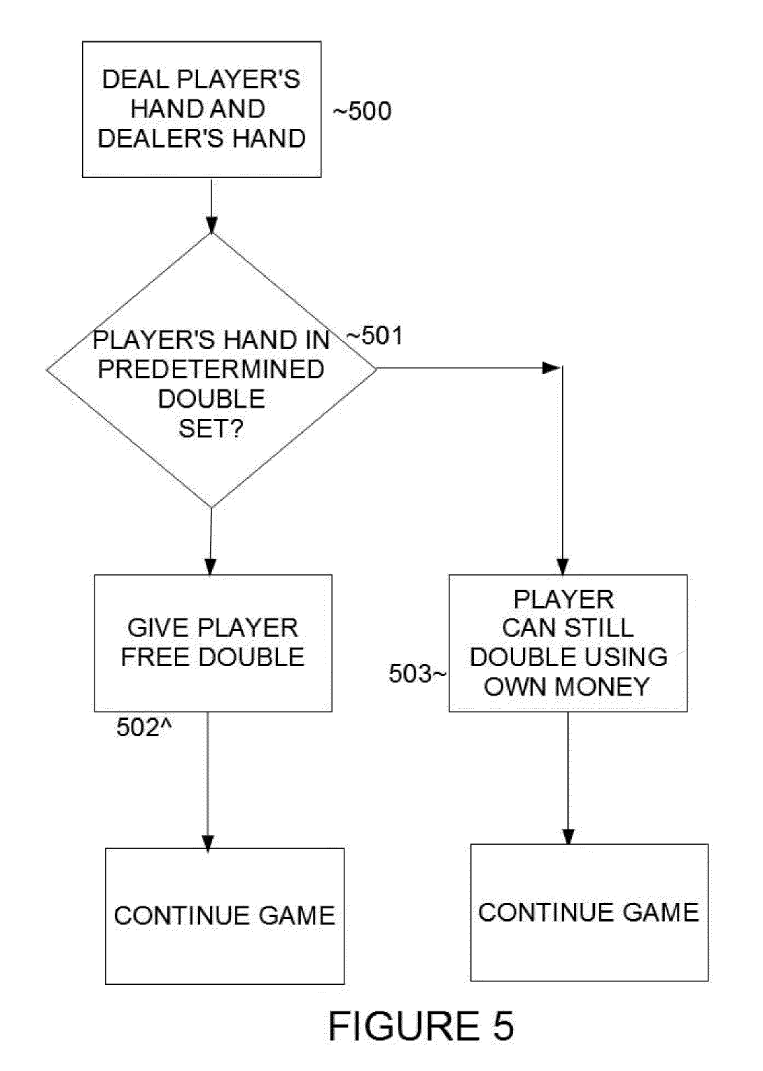

FIG. 5 is a flowchart illustrating an exemplary method of offering the player a free double, according to an embodiment. If the player has certain initial hands, the player can receive a “free” double from the house.

The method begins with operation 500, wherein the dealer deals the player's hand (two cards) and the dealer's hand. Operation 500 is analogous to operation 102 in FIG. 1 and the double action would be taken in operation 104 of FIG. 1. If the player doubles the player receives one additional card (like operation 106) but is not allowed to take any additional cards and the player then must stand (unless the one additional card causes the player to bust in which the player loses his main wager and his double wager).

From operation 500, the method proceeds to operation 501 which determines if the player's hand is in a predetermined double set (set of hands in which the player receives a free double).

A table such as Table III can be used to designate the set of initial player hands will qualify for the free double.

TABLE III

| Hand | Qualify for free double (in double set)? |
|---|---|
| Point total of 10 | yes |
| Point total of 11 | yes |
| Point total of 9 (5/4 only) | yes |
| All others | no |

In operation 501, if the player's hand is not in the predetermined double set (in this example, the hand is in the set if the hand has a point total of 10-11 or is comprised of the cards 5/4 (or 4/5)), then the method proceeds to operation 503, wherein the player is not offered a free double but the player can still double using their own money if they wish. The method then continues to operation 504.

If in operation 501 the player's hand is in the predetermined double set (for example the player's hand is a 6/5) then the method proceeds to operation 502, which gives the player a free double. The player can receive free chips (equal to the main wager or a lesser amount such as one half the main wager) which is placed alongside the main wager and is treated as if the player made this wager himself. This if the player wins, the player keeps all of the chips (the main wager, the free chips, and the payouts on the main wager and the free chips).

The player is not required to take the free double if the player does not want to. For example, consider the case where the player's initial point total (the initial two cards dealt to the dealer) is a 9, and assuming in the embodiment being played an initial total of 9 qualifies the player for a free double. Most players would likely take the free double, but a player could also decline the free double and hit the 9, for the reason that if the player doubles the player is limited to only one draw (double)) card but if the player hits the player can receive more than one draw card. Thus, in the case where the player's initial total is a 9, the player could take the free double and draw a 2 for 11, which is a terrible hand for the player (since on a double the player cannot draw any more cards). If the player declined the free double, then the player could have hit the hand, received the 2 (for a total of 11), and then hit again. Thus, the player should indicate to the dealer whether they wish to receive the free double bet or not (the same goes for the case of receiving the free split bet). Typically, there would be no reason for the player to decline the free double but use his/her own money to double (this may or may not be allowed depending on the house rules).

In another embodiment, instead of receiving free chips, the player can receive a non-cash value (NCV) chip which is used as a marker. Instead of matching the player's main wager, the dealer simply places a single NCV chip alongside the player's main wager. Note that the NCV chip has no cash value and is never kept by the player at the end of the game (if the player loses it is taken by the dealer and if the player wins the dealer pays a payout on the NCV chip but collects the NCV chip). Thus, for example, if the player makes a main wager of $2.50 and then gets a free double, the dealer will place the NCV chip alongside the player's main wager. If the player loses the double, then the dealer collects the player's main wager of $2.50 and also the NCV chip (thus the player has lost $2.50). If the player pushes the double, then the player does not get a payout but the dealer collects the NCV chip. If the player wins the double, then the dealer makes a $2.50 payout on the main wager and a $2.50 payout on the NCV chip (since the NCV chip represents a bet equal to the main wager) and the dealer would collect the NCV chip. Thus, the player has won $5.00 (there will be $7.50 in chips on the table but $2.50 was initially placed by the player).

From operation 502, the method/game continues wherein the player is dealt a double card (an additional card) and the game continues to operation 112 (from FIG. 1), unless the double card causes the player to bust in which the method would proceed to operation 110 (from FIG. 1). The free double is resolved as described herein along with the main wager.

From operation 503, the method continues to operation 104, wherein the player is free to take any action (hit, double, split, stand, etc.) although if the player still wants to double the player must do so with the player's own money.

It is noted that even if the player is entitled to the free double the player may decline the free double. The player may wish to do this in certain situations, since when doubling the player is only allowed one additional card, the player in some situations may decline the double when the player wishes to be able to draw more than one additional card. If the player declines the free double, then the player will not get the free chips (or NCV chip) and can play normally.

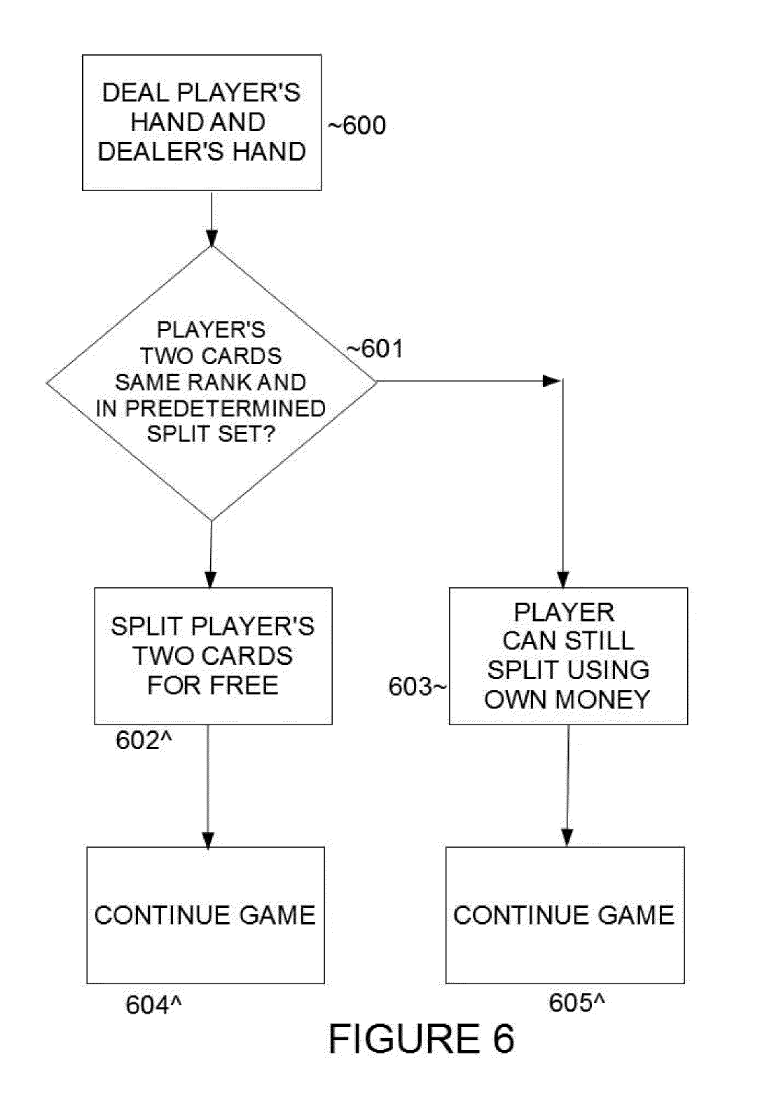

FIG. 6 is a flowchart illustrating an exemplary method of offering the player a free split, according to an embodiment. If the player has certain initial hands, the player can receive a “free” split from the house.

The method can begin with operation 600, which deals the player's hand (two cards) and the dealer's hand. Operation 600 is analogous to operation 102 in FIG. 1 and the split action would be taken in operation 104 of FIG. 1. In the standard blackjack game, splitting requires the player to place a wager equal to the main wager and the two initial cards (which must be of equal rank) are separated and played as two separate hands (each hand starts at operation 104 and plays out on its own). Cards can be resplit as long as they are of equal rank. Typically all 10-valued cards are allowed to be split as well (e.g., a jack and a queen can be split).

From operation 600, the method proceeds to operation 601, which determines if the player's two cards are the same rank (which qualifies them for a split) and are in the predetermined split set. A table such as Table IV can be used to designate which cards are in the predetermined split set. In one embodiment, certain initial hands may also be allowed to be split that are not of identical rank (e.g., a 3 and a 5).

TABLE IV

| Hand | Qualify for free split (in split set)? |
|---|---|
| 3/3 | yes |
| 4/4 | yes |
| 9/9 | yes |
| All others | no |

If the player's initial two cards (initial hand dealt in operation 600) are not in the split set then the method proceeds to operation 603, wherein the player can still split using the player's own money. The game would continue normally at operation 104.

If the player's initial two cards are in the split set, then the method proceeds to operation 602 and the player receives a free split. In one embodiment, the player will receive free chips matching the main wager which is used to for the split bet and the game proceeds normally as if the player had made the split using the player's own money. Or in another embodiment, the player would receive a lesser amount of chips than the main wager (e.g., half of the main wager) as the player's split bet which becomes the main wager for a second split hand using one of the initial cards (while the main wager is used for a first split hand using the other one of the initial cards).

In another embodiment, a NCV chip can be used by the house to make a wager for the free split hand instead of giving the player free chip(s). In this embodiment, the player receives an NCV chip alongside the main wager and the dealer uses the NCV chip for a first hand with one of the initial player's cards and the dealer uses the player's main wager for a second hand with the other one of the initial player's cards. For example, the player makes a $2.50 main wager (also known as an initial wager or simply the blackjack wager or the blackjack bet) and the player is dealt an initial two cards which qualify for the free split (e.g., 4/4 from Table IV). The dealer then places an NCV chip alongside the $2.50 main wager and the dealer separates the two 4's into two separate hands. Assuming the player plays out both hands (a first hand using a 4 and the NCV chip and a second hand using the other 4 and the $2.50 main wager) and wins both (without doubling on either), the dealer pays the player a $2.50 payout on the second hand and a $2.50 payout on the first hand while taking the NCV chip. Thus, the player has $7.50 in chips on the table the player can take for a profit of $5.00 (since the player started with an main wager of $2.50). If the player lost both hands, then the dealer would take all of the chips including the NCV chip. If the player won the first hand and lost the second hand, the dealer would pay $2.50 to the first hand and take the NCV chip and take the $2.50 main wager for the second hand resulting in an overall push for the player. If the player won the second hand and lost the first hand, then the dealer would take the NCV chip on the first hand and pay the player $2.50 on the second hand, leaving the player $5.00 in chips he can take (for an overall profit of $2.50).

Thus, it is noted that unlike a regular split (wherein the player makes an equal wager on both), in the embodiment using an NCV chip, the two split hands have different values as the player would be better off winning the one without the NCV chip (if of course the player were to not win both split hands). This is because the dealer always collects the NCV chip at the end of each game.

It is further noted that the player may decline the free split if the player does not wish to accept the free split. For example, if the player's initial two cards are two fives (and assuming two 5's qualifies the player for a free split) the player may decline the free split and play out the hand normally as a 10 (e.g., double, hit, etc.)

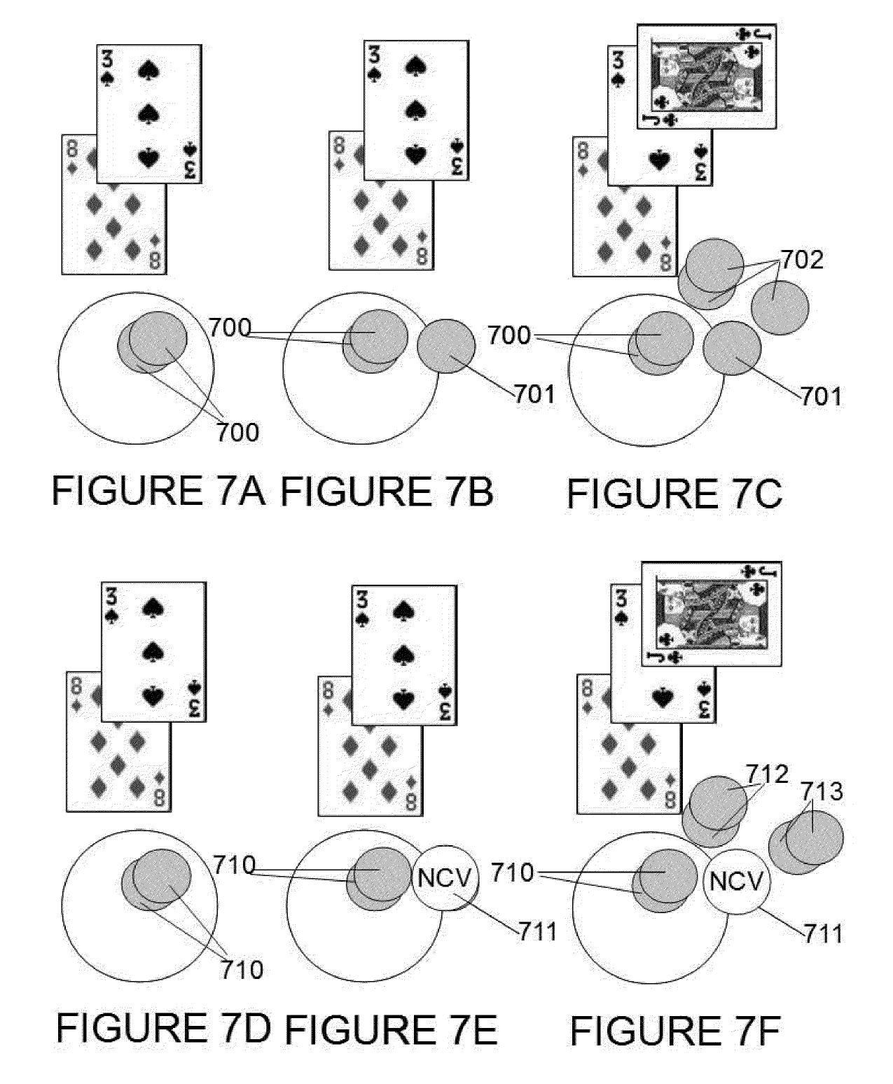

FIG. 7A is a drawing illustrating a first stage of a double using free chips, according to an embodiment.

The player makes a $2 main wager 700 comprising two $1 chips, and then is dealt the initial players card (or initial player's hand) of 8/3. Since the player's initial hand is in the double set (from Table III), the player qualifies for a free double.

FIG. 7B is a drawing illustrating a second stage of a double using free chips, according to an embodiment.

In this embodiment, the dealer provides the player one half of the player's main wager 700 in free chips as a $1 free double wager 701. In other embodiments, the dealer can match the player's main wager (or use any other multiple of the main wager).

FIG. 7C is a drawing illustrating a third stage of a double using free chips, according to an embodiment.

The player receives his double card and player wins the game (e.g., the dealer busts). The dealer pays the player a $3 payout 702 which matches the player's main wager (also referred to as initial wager) 700 and the free double wager 701. The player now has $6 in chips to keep (for a profit of $4). If the player lost the game, the dealer would collect all of the chips which means the player would have lost $2 of his own money on the game.

FIG. 7D is a drawing illustrating a first stage of a double using a non-cash value chip, according to an embodiment. Instead of giving the player free chip(s), a non-cash value (NCV) chip can be used which can simplify the dealer's need for counting out chips. The NCV chip can be a chip different in appearance from the other chips (e.g., a silver coin) which can say “free double.”

The player places a $2 main wager 710 (2 $1 chips) and is dealt a hand which qualifies the player for a free double (assuming the player accepts the free double).

FIG. 7E is a drawing illustrating a second stage of a double using a non-cash value chip, according to an embodiment.

The dealer places a NCV chip 711 alongside the player's main wager.

FIG. 7F is a drawing illustrating a third stage of a double using a non-cash value chip, according to an embodiment.

The dealer then deals the player the double card (jack clubs) and wins the game (e.g., the dealer has a point total of 18). The dealer now pays a $2 main wager payout 712 equal to the main wager and a $2 NCV payout 713 also equal to the main wager. The dealer will then collect (keep) the NCV chip 711. Thus, the player now has $6 in chips to keep for an overall profit of $4.

The outcome in this case is the same as in the standard game since when the player wins with a NCV chip, the player wins an amount that would have been equal to if the player doubled normally. However, if the player lost, then using an NCV chip the player would only lose his/her main wager. Compare this to the situation where if the player was playing a standard (prior art) game of blackjack and doubled and lost, then the player would have lost double the main wager (the main wager plus the double wager). Thus, the blackjack variation described herein can reduce a player's exposure to losses during doubles (and splits).

Note that the method illustrated in FIGS. 7A-7C is mathematically equivalent to the method illustrated in FIGS. 7D-7F but the latter method may be easier and more quicker to deal (since the dealer only needs to use an NCV chip and not count out exact chips to match the main wager).

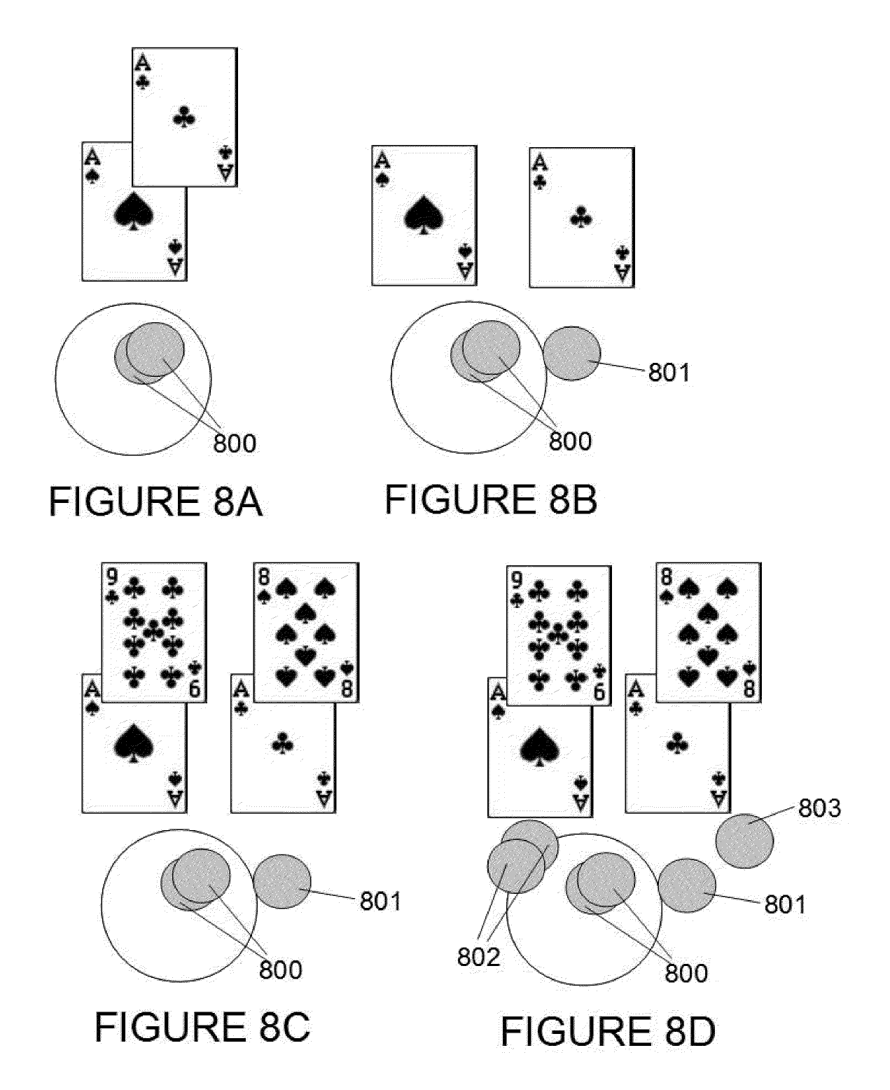

FIG. 8A is a drawing illustrating a first stage of a split using free chips, according to an embodiment.

The player places a $2 main wager 800 and is dealt two aces and in this embodiment two aces would qualify the player for a free split.

FIG. 8B is a drawing illustrating a second stage of a split using free chips, according to an embodiment.

The dealer splits the two aces into separate hands and places a free split wager 801 alongside the main wager 800, the $1 free split wager 801 being one half of the main wager 800. In other embodiments, the free split wager can be equal (match) the player's main wager or can be any other multiple.

FIG. 8C is a drawing illustrating a third stage of a split using free chips, according to an embodiment.

The dealer has completed each game on its own (the player has chosen to stand on each hand). Assume the player has won both hands (e.g., the dealer busts).

FIG. 8D is a drawing illustrating a fourth stage of a split using free chips, according to an embodiment.

The dealer pays the player a $2 main wager payout 802 matching the main wager 800 and also pays the player a $1 free split payout 803 which matches the free split wager 801, for a total payout to the player of $3. The player now has $6 in chips on the table the player can keep (for a profit of $4).

If the player lost both hands, then the dealer would collect the main wager 800 and the free split wager 801. If the player won the left hand and lost the right hand, then the player would pay the player the $2 main wager payout 802 but take the free split wager 801 leaving the player with $4 in chips the player can keep for an overall profit of $2. If the player loses the left hand and wins the right hand then the dealer would collect the main wager 800 and pay the player the free split payout 803 leaving the player with $2 in chips the player can keep for an overall push (player breaks even).

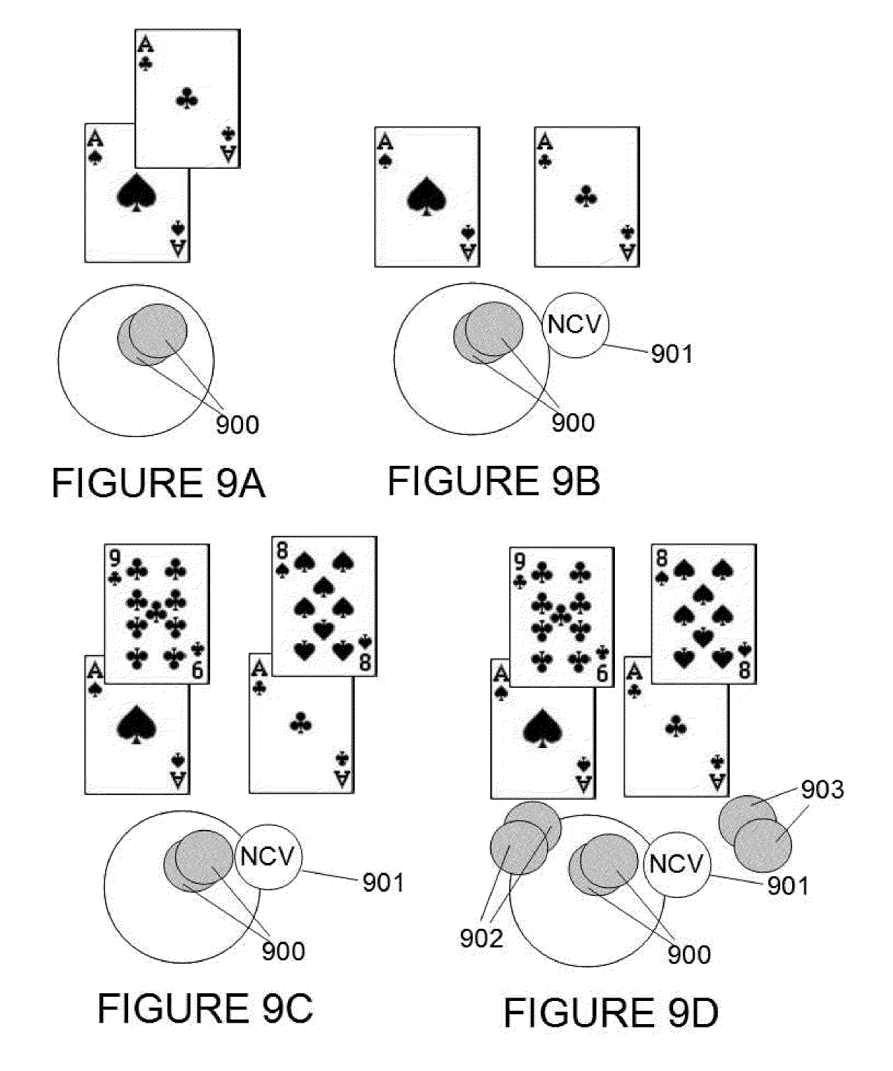

FIG. 9A is a drawing illustrating a first stage of a split using a non-cash value chip, according to an embodiment.

The player makes a $2 main wager 900 of two $1 chips. The player is dealt two aces which according to the house rules currently in play would qualify the player for a free split.

FIG. 9B is a drawing illustrating a second stage of a split using a non-cash value chip, according to an embodiment.

The dealer separates the two aces and places a NCV chip 901 alongside the main wager 900.

FIG. 9C is a drawing illustrating a third stage of a split using a non-cash value chip, according to an embodiment.

Each of the two hands is played out individually. Assume the player decides to stand on both hands and wins both hands (e.g., the dealer ends up with a point total of 17).

FIG. 9D is a drawing illustrating a fourth stage of a split using a non-cash value chip, according to an embodiment.

The dealer pays the player a $2 main wager payout 902 matching the main wager 900 and also pays the player a $2 NCV payout 903 matching the main wager. Thus, there is now $6 in chips on the table the player can collect (for an overall profit of $2) while the dealer collects the NCV chip 901.

If the player lost both hands, then the dealer would collect the main wager 900 and the NCV chip 901 leaving the player with nothing (a loss of $2). If the player won the left hand and loses the right hand, then the player would receive a main wager payout 902 of $2 and the dealer would collect the NCV chip 901 leaving the player with $4 in chips on the table the player can keep (for a profit of $2). If the player loses the left hand and wins the right hand, then the player loses the main wager 900 and wins a $2 NCV payout 903 while the dealer collects the NCV chip 901 leaving $2 in chips on the table the player can keep (meaning the player pushes or breaks even on the game).

Note that the method illustrated in FIGS. 8A-8D is mathematically identical to the method illustrated in FIGS. 9A-9D, although the latter method may be easier and quicker for the dealer to deal.

In an embodiment, the free split feature can be combined with the free double feature. For example, if the player qualifies for and receives a free split and then on one (or both) of the split hands the player has the first two cards that qualify for a free double then the player would receive a free double as well (“doubling after splitting”). If the player receives a free split and one (or both) of the split hands are two identically ranked cards then those hand(s) would qualify for another free split as well (“re-splitting pairs”).

Table IV below illustrates one exemplary set of rules that combines the free doubling with the free splitting. Of course, other sets of rules can be used as well and the set illustrated in Table IV is merely one example. Other rule variants can include: dealer stands on soft 17; no surrender available; doubling (free double and regular doubling) only offered on initial two cards; blackjacks pay 6:5; blackjacks pay even money.

TABLE IV
6 decks
Dealer hits soft 17's
Blackjacks pay 3 to 2
Double after split allowed
Double on two cards only
Re-split pairs up to four hands, including aces
Split aces receive one card only
Late surrender allowed
Free doubles on hard initial two card totals of 9, 10, or 11 with any number of cards. With a free
double, the player's main wager is matched with a non-cash value chip and the player receives
one additional card. At the end of the hand: a) If the dealer wins, the player loses his/her original
wager only b) If the hand results in a push, the player gets back his original wager only; c)
Otherwise, if the player wins, the player gets back his original wager plus winnings equal to
double that wager.
Dealer pushes on 22. If the player has 21 or less and the dealer busts with a point total of 22, then
the player's wager is a push (instead of winning as in conventional blackjack)
Free splits on all pairs except 10's. With a free split, the player's initial two cards are divided into
two one-card hands. The player's main wager is placed with the first hand and a non-cash value
chip is placed with the second hand. The player plays out each hand one at a time and is also
entitled to a “free double” or “free split” on both hands. For winning hands, each non-cash value
chip is replaced with real chips equaling the original wager. On hands resulting in a player loss or
push, the dealer takes back the non-cash value chip.

Preferably, the NCV chip would different in size and appearance than any of the other chips a casino uses so that it would not be mistaken for a chip with value. If a player happens to possess a NCV chip (although in theory the dealer would always collect the NCV chips at the end of each game) the player will not be able to cash it in at the cashier as it would have no cash value.

It is noted that the methods described herein can be played with any number of standard decks (physical or virtual) of 52 cards (e.g., 1 deck to 10 decks). Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a blackjack game, the method comprising:
providing at least one physical deck of cards;
providing free double rules which comprise when the player is initially dealt a two card hand in a set of qualifying two card hands, the player is provided an opportunity to make a free double wherein the a free double wager is made without the player having to use the player's own money, and upon resolving of the main wager if the player wins the main wager then the player wins the free double wager and if the player loses the main wager then the player does not lose any money in addition to the main wager;
receiving a main wager from a player;
dealing an initial hand to the player and an initial hand to the dealer;
implementing the free double rules;
continuing and completing the blackjack game; and
resolving the main wager.

2. The method as recited in claim 1, wherein the free double rules further comprise that when the main wager ties, the free double wager also ties.

3. The method as recited in claim 1, wherein the free double rules further comprises than when a free double wager is made a single non-cash value chip is used to designate the free double wager.

4. The method as recited in claim 1, further providing and implementing free split rules which comprise when the player is initially dealt a two card hand in a set of qualifying two card hands, the player is provided an opportunity to make a free split wherein the player's initial two cards are split into two separate hands with a free split wager being made on a second of the two separate hands with the main wager being assigned to the first of the two separate hands, and if the second of the two separate hands wins then the free split wager is paid at an amount equal to the main wager and if the second of the two separate hands loses then the player does not lose any money.

5. The method as recited in claim 4, wherein the free double split further comprise than when a free split wager is made a single non-cash value chip is used to designate the free split wager.

6. A method for implementing a blackjack game, the method comprising:
executing the following operations on an electronic processing unit:
providing free double rules which comprise when the player is initially dealt a two card hand in a set of qualifying two card hands, the player is provided an opportunity to make a free double wherein the a free double wager is made without the player having to use the player's own money, and upon resolving of the main wager if the player wins the main wager then the player wins the free double wager and if the player loses the main wager then the player does not lose any money in addition to the main wager;
receiving a main wager from a player;
dealing an initial hand to the player and an initial hand to the dealer;
implementing the free double rules;
continuing and completing the blackjack game; and
resolving the main wager.

7. The method as recited in claim 6, wherein the free double rules further comprise that when the main wager ties, the free double wager also ties.

8. The method as recited in claim 6, wherein the free double rules further comprises than when a free double wager is made a single non-cash value chip is used to designate the free double wager.

9. The method as recited in claim 6, further providing and implementing free split rules which comprise when the player is initially dealt a two card hand in a set of qualifying two card hands, the player is provided an opportunity to make a free split wherein the player's initial two cards are split into two separate hands with a free split wager being made on a second of the two separate hands with the main wager being assigned to the first of the two separate hands, and if the second of the two separate hands wins then the free split wager is paid at an amount equal to the main wager and if the second of the two separate hands loses then the player does not lose any money.

10. The method as recited in claim 9, wherein the free double split further comprise than when a free split wager is made a single non-cash value chip is used to designate the free split wager.

11. A apparatus for implementing a blackjack game, the apparatus comprising:
an electronic output device;
an electronic input device;
an electronic processing unit connected to the electronic output device and the electronic input device, the electronic processing unit configured to:
provide at least one physical deck of cards;
provide free double rules which comprise when the player is initially dealt a two card hand in a set of qualifying two card hands, the player is provided an opportunity to make a free double wherein the a free double wager is made without the player having to use the player's own money, and upon resolving of the main wager if the player wins the main wager then the player wins the free double wager and if the player loses the main wager then the player does not lose any money in addition to the main wager;
receive a main wager from a player;
deal an initial hand to the player and an initial hand to the dealer;
implement the free double rules;
continue and complete the blackjack game; and
resolve the main wager.

12. The apparatus as recited in claim 11, wherein the processing unit is further configured such that the free double rules further comprise that when the main wager ties, the free double wager also ties.

13. The apparatus as recited in claim 11, wherein the processing unit is further configured such that the free double rules further comprises than when a free double wager is made a single non-cash value chip is used to designate the free double wager.

14. The apparatus as recited in claim 11, wherein the processing unit is further configured to provide and implement free split rules which comprise when the player is initially dealt a two card hand in a set of qualifying two card hands, the player is provided an opportunity to make a free split wherein the player's initial two cards are split into two separate hands with a free split wager being made on a second of the two separate hands with the main wager being assigned to the first of the two separate hands, and if the second of the two separate hands wins then the free split wager is paid at an amount equal to the main wager and if the second of the two separate hands loses then the player does not lose any money.

15. The apparatus as recited in claim 14, wherein the processing unit is further configured to provide such that the free double split further comprise than when a free split wager is made a single non-cash value chip is used to designate the free split wager.
